(19) United States
(12) Patent Application Publication
(10) Pub. No.: US 2006/0234647 A1
(43) Pub. Date: Oct. 19, 2006

(54) Receiver and transmitter of a frequency-modulated signal

(76) Inventor: Anthony Kerselaers, Louvain (BE)

Correspondence Address: PHILIPS INTELLECTUAL PROPERTY & STANDARDS, P.O. BOX 3001, BRIARCLIFF MANOR, NY, 10510, US

(21) Appl. No.: 10/555,053

(22) PCT Filed: Apr. 29, 2004
(86) PCT No.: PCT/IB04/50550

§ 371 Date: Oct. 28, 2005

(30) Foreign Application Priority Data
May 2, 2003 (EP) 03101212.3

(51) Int. Cl. H04B 1/38

(52) U.S. Cl. 455/73

(57) ABSTRACT

The receiver of the invention consists of a non-baseband component (1), a frequency demodulator (3), and a baseband component (5). The non-baseband component (1) causes a first group delay variation in a frequency-modulated non-baseband signal while processing the non-baseband signal. The first group delay variation in the frequency modulated non-baseband signal results in a second group delay variation in the demodulated baseband signal. The baseband component (5) is able to substantially compensate the second group delay variation in the demodulated baseband signal. The transmitter of the invention consists of a baseband component (21), a frequency modulator (23), and a non-baseband component (25). The baseband component (21) is able to cause a first group delay variation in an unmodulated baseband signal. The first group delay variation in the unmodulated baseband signal results in a second group delay variation in the frequency-modulated nonbaseband signal. The non-baseband component (25) for processing the frequency-modulated non-baseband signal has a certain group delay characteristic. This certain group delay characteristic is substantially compensated by the second group delay variation.

The invention relates to a receiver of a frequency-modulated signal.

The invention further relates to a transmitter of a frequency-modulated signal.

Such a receiver is known from various types of mobile communication devices and from radio sets with FM tuners. Radio sets with FM tuners sets are able to use such a receiver for receiving and demodulating frequency-modulated analog audio signals. Mobile communication devices using the DECT standard for cordless telephony or the ZigBee standard for personal area networking comprise transmitters with frequency modulators and receivers with frequency demodulators. In these mobile communication devices, a digital signal is modulated onto two or four different frequencies centered around a carrier frequency. This is called Frequency Shift Keying (FSK). Signals that have been frequency-modulated, e.g. analog FM or digital FSK-modulated signals, suffer from group delay variation caused by some components in transmitters and/or receivers. Group delay is the negative derivative of the phase versus frequency characteristic of a device or component. Group delay variation may cause intersymbol interference in FSK-modulated signals, thereby causing degraded bit error rate performance. It is a drawback of the known receiver that group delay variation can only be reduced by using expensive components.

It is a first object of the invention to provide a receiver of the kind described in the opening paragraph, in which group delay variation is minimized in a cost-effective manner.

It is a second object of the invention to provide a transmitter of the kind described in the opening paragraph, in which group delay variation is minimized in a cost-effective manner.

According to the invention, the first object is realized in that the receiver comprises: a non-baseband component which is able to process a frequency-modulated non-baseband signal, the non-baseband component causing a first group delay variation in the frequency-modulated non-baseband signal; a frequency demodulator for demodulating the frequency-modulated non-baseband signal, the first group delay variation in the frequency-modulated non-baseband signal resulting in a second group delay variation in the demodulated baseband signal; and a baseband component which is able to substantially compensate the second group delay variation in the demodulated baseband signal. Although it may seem most logical to compensate a group delay before demodulation, a baseband component can often be manufactured at lower cost. This advantage is due to the fact that the baseband component processes near-zero frequencies, which can be stabilized more easily than higher frequencies. In general, the baseband component will need to be specifically adapted for use with the non-baseband component.

In an embodiment of the receiver of the invention, the baseband component comprises a baseband filter. A baseband filter is useful for, for example, noise reduction. By adding an extra group delay variation compensation function to the baseband filter, two functions may be realized with a single physical component.

The baseband filter may comprise a Gaussian filter adapted to compensate the second group delay variation in the demodulated baseband signal. A standard Gaussian filter will have no substantial group delay variation, but a Gaussian filter may be adapted to have one of many different group delay characteristics. A Gaussian filter is also very suitable for noise reduction.

The non-baseband component may comprise an intermediate frequency filter. Before a Radio Frequency signal is converted into a baseband signal, it is generally first converted into an intermediate frequency (IF) signal, e.g. a signal in the 10.7 Mhz band. The IF signal is filtered in order to select wanted transmitters and reject unwanted, nearby transmitters. If a filter is not ideal, noise and group delay variation may be the result. A combination of filters may provide better rejection and less noise than a single filter. A combination of filters may comprise, for example, two ceramic IF filters and a Gaussian baseband filter.

The intermediate frequency filter may comprise a ceramic filter. Intermediate frequency filters, especially ceramic filters, are a common source of group delay variation. The inventors have recognized that compensating group delay variation caused by a ceramic IF filter in another physical component can be cheaper than replacing the cheap ceramic filter by a more expensive filter, e.g. a SAW filter. As an additional advantage, ceramic filters also provide better selectivity than some more expensive filters, e.g SAW filters.

According to the invention, the second object is realized in that the transmitter comprises: a baseband component which is able to cause a first group delay variation in an unmodulated baseband signal; a frequency modulator for frequency-modulating the unmodulated baseband signal, the first group delay variation in the unmodulated baseband signal resulting in a second group delay variation in the frequency-modulated non-baseband signal; and a non-baseband component which is able to process the frequency-modulated non-baseband signal, the non-baseband component having a certain group delay characteristic and the certain group delay characteristic being substantially compensated by the second group delay variation. Group delay variation may be caused in non-baseband components of a transmitter, just like in non-baseband components of a receiver. However, in the transmitter, the group delay variation has to be pre-compensated.

In an embodiment of the transmitter of the invention, the baseband component comprises a baseband filter. A Gaussian baseband filter is used in, for example, Gaussian Frequency Shift Keying (GFSK) transmitters to achieve spectrum efficiency.

The baseband filter may comprise a Gaussian filter adapted to cause the first group delay variation in the unmodulated baseband signal. A standard Gaussian filter will have no substantial group delay variation, but a Gaussian filter may be adapted to have one of many different group delay characteristics.

These and other aspects of the receiver and the transmitter of the invention will be further elucidated and described with reference to the drawings, in which:

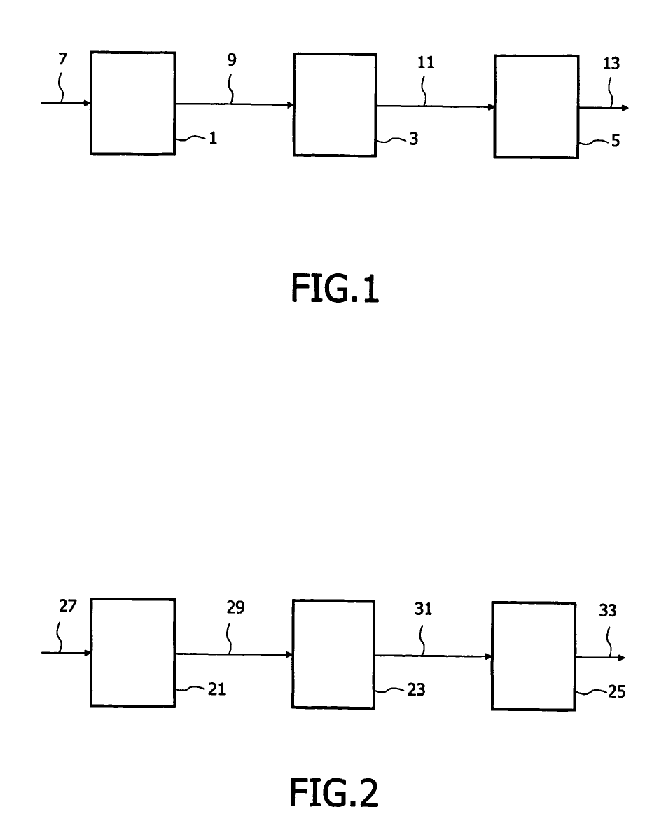

FIG. 1 is a block diagram of the receiver,

FIG. 2 is a block diagram of the transmitter;

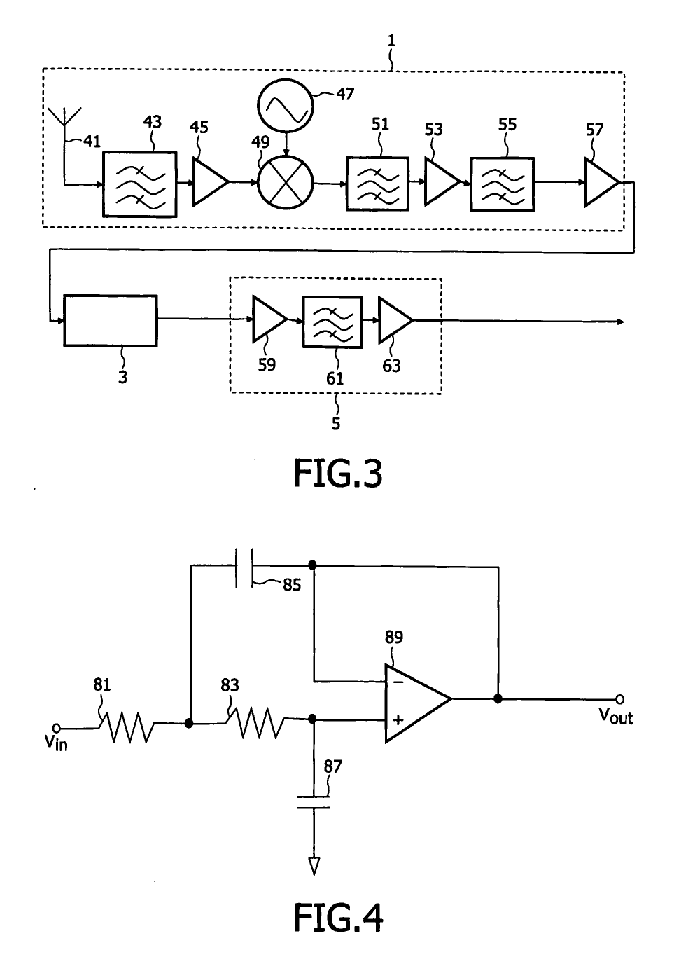

FIG. 3 is a block diagram of an embodiment of the receiver;

FIG. 4 is a block diagram of an embodiment of a Gaussian filter;

Corresponding elements in the drawings are identified by the same reference numerals.

The receiver of the invention, see FIG. 1, comprises a non-baseband component 1 which is able to process a frequency-modulated non-baseband signal 7, the non-baseband component causing a first group delay variation in the frequency-modulated non-baseband signal 7, resulting in a frequency-modulated non-baseband signal 9. The receiver further comprises a frequency demodulator 3 for demodulating the frequency-modulated non-baseband signal 9, the first group delay variation in the frequency-modulated non-baseband signal 9 resulting in a second group delay variation in the demodulated baseband signal 11. The receiver also comprises a baseband component 5 which is able to substantially compensate the second group delay variation in the demodulated baseband signal 11, resulting in a demodulated baseband signal 13. The receiver may be able to receive, for example, optical frequency-modulated signals or radio frequency-modulated signals. The frequency demodulator 3 may be part of a GFSK demodulator. The frequency demodulator 3 may comprise one or more physical components. The non-baseband component 1, the demodulator 3, and the baseband component 5 may be integrated into one or more integrated circuits.

The transmitter of the invention, see FIG. 2, comprises a baseband component 21 which is able to cause a first group delay variation in an unmodulated baseband signal 27, resulting in an unmodulated baseband signal 29. The transmitter further comprises a frequency modulator 23 for frequency-modulating the unmodulated baseband signal 29, the first group delay variation in the unmodulated baseband signal 29 resulting in a second group delay variation in the frequency-modulated non-baseband signal 31. The transmitter also comprises a non-baseband component 25 which is able to process the frequency-modulated non-baseband signal 31, the non-baseband component 25 having a certain group delay characteristic and the certain group delay characteristic being substantially compensated by the second group delay variation. The resulting non-baseband signal 33 will have no substantial group delay caused by the non-baseband component 25. The transmitter may be able to transmit, for example, optical frequency-modulated signals or radio frequency-modulated signals. The frequency modulator 23 may be part of a GFSK modulator. The frequency modulator 23 may comprise one or more physical components. The baseband component 21, the demodulator 23, and the non-baseband component 25 may be integrated into one or more integrated circuits.

An embodiment of the receiver is shown in FIG. 3. In this embodiment, the receiver is a GFSK receiver. The receiver comprises a non-baseband component 1, a frequency demodulator 3, and a baseband component 5. The non-baseband component 1 comprises an antenna 41, an RF filter 43, a low-noise amplifier 45, an oscillator 47, a mixer 49, a first intermediate-frequency (IF) filter 51, an IF amplifier 53, a second IF filter 55, and a limiter amplifier 57. Alternatively, the non-baseband component may comprise multiple antennas and an antenna-diversity switch. The low-noise amplifier 45 sets the sensitivity of the receiver while isolating the oscillator from leaking into the antenna 41. The RF filter 43 may be a SAW filter. The IF filters 51 and 55 may comprise ceramic filters. The baseband component 5 comprises a buffer amplifier 59, a baseband filter 61, and an A/D converter 63. The baseband filter 61 may comprise a Gaussian filter adapted to compensate the second group delay variation in the demodulated baseband signal. The A/D converter 63 converts the filtered baseband signal into a digital signal for a baseband processor. Alternatively, the A/D converter 63 may be replaced by a slicer circuit. The modulation may be, for example, 2-level GFSK, duo binary GFSK, or 4-level GFSK.

In an embodiment of the receiver and/or the transmitter of the invention, the receiver and/or the transmitter may comprise a Gaussian filter. An embodiment of a Gaussian filter, a second-order low-pass Gaussian filter, is shown in FIG. 4. The second-order low-pass Gaussian filter comprises a first resistor 81, a second resistor 83, a first capacitor 85, a second capacitor 87, and a differential amplifier 89. A signal enters the circuit before the first resistor 81. The other side of the first resistor 81 is connected to both the second resistor 83 and the first capacitor 85. The other side of the second resistor 83 is connected to both the second capacitor 87 and the positive input of the differential amplifier 89. The other side of the second capacitor 87 is connected to ground of the circuit. The other side of the first capacitor 85 is connected to both the negative input and the output of the differential amplifier 89. The output of the differential amplifier 87 is also used as output of the circuit. The group delay response of the Gaussian filter may be adapted by varying the capacity of the second capacitor 87. Alternatively, the Gaussian filter may be implemented by a different circuit or in a digital signal processor (DSP). In the latter embodiment, the demodulated baseband signal is sampled into the DSP and the DSP performs noise reduction and group delay compensation with a digital filter. A signal analyzer could be used to measure which group delay response of the Gaussian filter compensates the group delay variation of the non-baseband component.

While the invention has been described in connection with favorable embodiments, it will be understood that modifications thereof within the principles outlined above will be evident to those skilled in the art, and thus the invention is not limited to the preferred embodiments but is intended to encompass such modifications. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. A receiver of a frequency-modulated signal, comprising:
a non-baseband component (1) which is able to process a frequency-modulated non-baseband signal, the non-baseband component causing a first-group delay variation in the frequency-modulated non-baseband signal;
a frequency demodulator (3) for demodulating the frequency-modulated non-baseband signal, the first group delay variation in the frequency-modulated non-baseband signal resulting in a second group delay variation in the demodulated baseband signal; and
a baseband component (5) which is able to substantially compensate the second group delay variation in the demodulated baseband signal.

2. A receiver as claimed in claim 1, wherein the baseband component (5) comprises a baseband filter (61).

3. A receiver as claimed in claim 2, wherein the baseband filter (61) comprises a Gaussian filter adapted to compensate the second group delay variation in the demodulated baseband signal.

4. A receiver as claimed in claim 2, wherein the non-baseband component (1) comprises an intermediate-frequency filter (51, 55).

5. A receiver as claimed in claim 4, wherein the intermediate-frequency filter comprises a ceramic filter.

6. A transmitter of a frequency-modulated signal, comprising:
a baseband component (21) which is able to cause a first group delay variation in an unmodulated baseband signal;
a frequency modulator (23) for frequency-modulating the unmodulated baseband signal, the first group delay variation in the unmodulated baseband signal resulting in a second group delay variation in the frequency-modulated non-baseband signal; and
a non-baseband component (25) which is able to process the frequency-modulated non-baseband signal, the non-baseband component having a certain group delay characteristic and the certain group delay characteristic being substantially compensated by the second group delay variation.

7. A transmitter as claimed in claim 6, wherein the baseband component (21) comprises a baseband filter.

8. A transmitter as claimed in claim 7, wherein the baseband filter comprises a Gaussian filter adapted to cause the first group delay variation in the unmodulated baseband signal.
